(19) United States
(12) Patent Application Publication
(10) Pub. No.: US 2018/0116182 A1
(43) Pub. Date: May 3, 2018

(54) Beehive protection system (The Hive Jacket)

(71) Applicant: William Theodoro Frey, Byron, IL (US)

(72) Inventor: William Theodoro Frey, Byron, IL (US)

(21) Appl. No.: 15/330,745

(22) Filed: Nov. 2, 2016

(51) Int. Cl. A01K 47/06

(52) U.S. Cl. CPC A01K 47/06

(57) ABSTRACT

The Hive Jacket is a system of covers which assemble to protect managed honey-bee hives from extreme cold weather elements is disclosed. This invention incorporates a system of flexible sections which will encapsulate the hive providing top to bottom coverage. The modular nature of The Hive Jacket allows for the system to be used with any height hive. Each section of this invention is sized to fit both 8 and 10 frame width hive body sizes. The system is fashioned to fit snugly and constructed from air permeable materials. These features will ensure proper hive ventilation, free and easy egress for the bees, allow beekeepers unrestricted access to the colony for keeping duties, and allow for the use on nearly any managed bee hive body.

### BACKGROUND

Each year, in geographic areas that experience harsh winter conditions, there are significant losses to managed honeybee colonies. These losses from freezing temps and wind-chill can range from 30% to the loss of entire colonies.

Most honeybees are kept in hives, which are little more than wooden boxes with little or no insulation. This arrangement leaves colonies susceptible to the effects of wind chill and deep-freezing conditions. Actions to insulate hives by the Bee Keeper using home made solutions often result in the following problems; moisture build up inside the hive leading to colony wide hypothermia, hive entrance blockages preventing the egress of bees for cleansing activities causing dysentery and other illnesses, and improvised insulation solutions also limit Keeper access to the hive for beekeeping inspections and other activities.

### SUMMARY OF THE INVENTION

This invention incorporates a system of flexible, fabric sections that assemble to encapsulate the hive, providing top to bottom protection. It is designed to fit the numerous heights and widths that standard hive bodies are made in. The system is constructed of air permeable materials allowing for proper hive ventilation and its modular nature allows complete access for the Bee Keeper and unobstructed egress for the bees.

### SUMMARY OF THE DRAWINGS

FIG. 1: Sketch of a Langstroth, Dadent or Illinois style managed bee hive.

FIG. 2: A representation of a fully asymbled Hive Jacket System integrated with a Langstroth hive (FIG. 1).
FIG. 2.1: Hive Jacket Top Cover Section
FIG. 2.2: Hive Jacket Honey Super Section
FIG. 2.3: Hive Jacket Brood Chamber Section

FIG. 3: Hive Jacket Top Cover Section
FIG. 3.1: Top Cover—Edge View
FIG. 3.2: Top Cover—Straight On View

FIG. 4: Hive Jacket Top Cover Bottom View
FIG. 4.1: Elastic Straps which extend over the four corners of the Hive Top keeping Hive Jacket Top Cover in place.

FIG. 5: Exploded View of Hive Jacket Top Cover with measurements.

FIG. 6: Hive Jacket Honey Super Section—Full Closed View
FIG. 6.1: Velcro Strips
FIG. 6.2: Nylon Webbing
FIG. 6.3 Parachute Clips

FIG. 7: Hive Jacket Honey Super Section—Back View
FIG. 7.1: Velcro Strip
FIG. 7.2: Parachute Clips and Nylon Webbing

FIG. 8: Hive Jacket Honey Super Section—Front View
FIG. 8.1: Velcro Strip
FIG. 8.2: Parachute Clips and Nylon Webbing

FIG. 9: Hive Jacket Brood Chamber Section—Full Closed View
FIG. 9.1: Velcro Strips
FIG. 9.2: Nylon Webbing
FIG. 9.3: Parachute Clips

FIG. 10: Hive Jacket Brood Chamber Section—Back View
FIG. 10.1: Velcro Strip
FIG. 10.2: Parachute Clips and Nylon Webbing

FIG. 11: Hive Jacket Brood Chamber Section—Front View
FIG. 11.1: Velcro Strip
FIG. 11.2: Parachute Clips and Nylon Webbing

### DETAILED DESCRIPTION

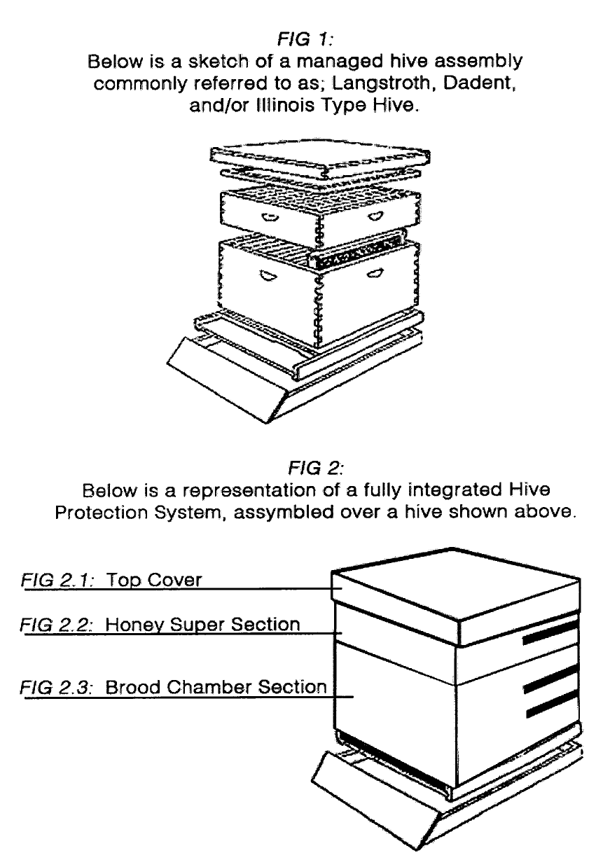

The Hive Jacket is comprised of insulated fabric sections, which can be assembled to cover any size hive Langstroth type managed honey bee hive (FIG. 1). The sections are as follows, a top cover (FIG. 2.1), honey super section (FIG. 2.2), and brood chamber section (FIG. 2.3). Apart from the top cover, any combination of honey super sections and brood chamber sections or multiples of these sections, can be added or subtracted to cover any size hive. All components of the system are constructed of a PVC outer shell, insulating inner layer, batting layer, and cotton/polyester inner shell.

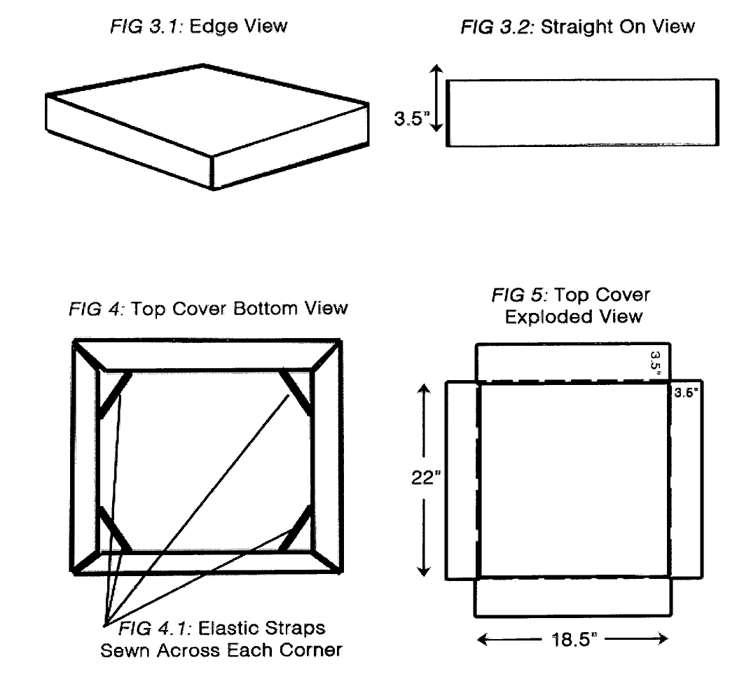

Top Cover Section (FIG. 3): Dimensions are covered in the illustrations shown in the illustration (FIG. 5). Attached to each corner of this section are elastic straps (FIG. 4.1), which extend over each corner of a hive top to secure the top cover section to the hive.

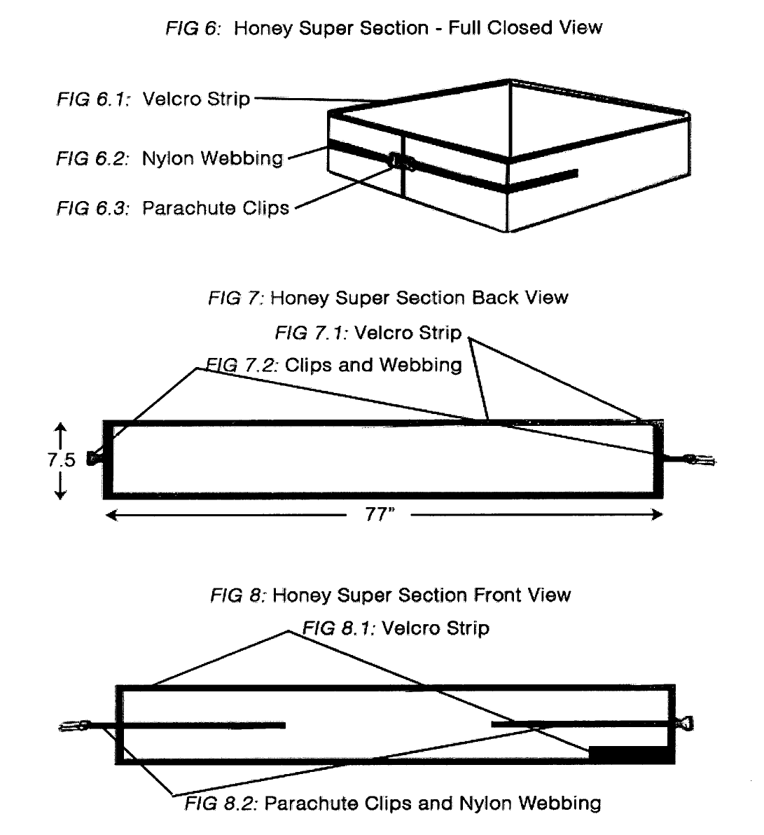

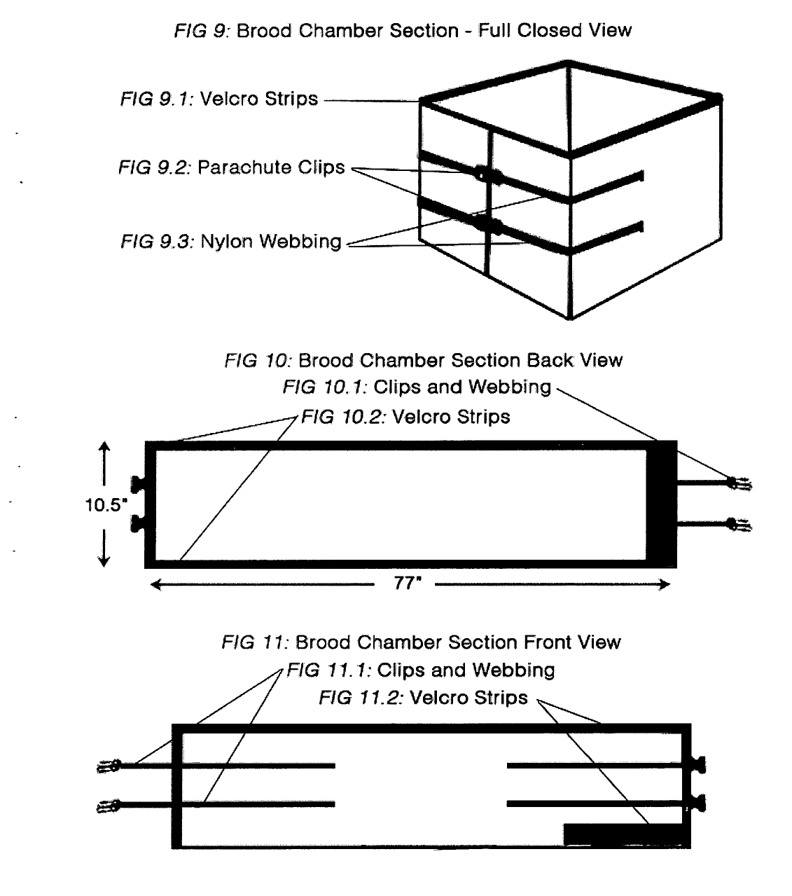

Honey Super Sections (FIG. 6): Dimensions are covered in the illustrations at FIG. 7. These sections are equipped with Velcro (hook and loop) strips (FIGS. 6.1, 7.1, 8.1) outlining the edges of each component. The Velcro is used to secure the sections to one another and ensure a proper fit on both larger 10 frame and 8 frame boxes. Nylon Webbing straps (FIGS. 6.2, 7.2, 8.2) are sewn to each section and clasp together at the rear of the hive securing all components to the hive with plastic parachute clips (FIGS. 6.3, 7.2, 8.2).

### The Version of he Invention Discussed Here Includes the Following Materials

1. Water Proof PVC Fabric (outer shell)

2. Insulating Fabric Inner Layer

3. Synthetic Fabric Batting Inner Layer

4. Polyester/Cotton Fabric (inner shell)

5. Elastic Straps (top cover)

6. Straps—Nylon Webbing

7. Hook and Loop Strips (Velcro)

8. Heavy Duty Thread

### Relationship Between the Components

The Hive Jacket comes in three sections; Top Cover, Honey Super, and Brood Chamber covers. Each component is constructed of a water proof outer shell and polyester/cotton inner shell enveloping the insulation and batting inner layers. Multiple Honey Super and Brood Chamber sections can be added to increase jacket height to fit any height hive.

The Top cover is placed on the hive top with its four sides draped over the edges of the hive cover. The elastic straps sewn across each corner of the top cover are extended down and over each corner of the hive top. The lower Brood Chamber section is wrapped around the hive with the loose ends overlapping at the rear and attached to one another with the Velcro. Once a snug fit is achieved, the plastic parachute clips attached to the nylon webbing straps are fastened at the rear of the hive and any slack in the straps is removed. The next section in the system is then attached to the lower section by overlapping the Velcro strips on each section. Once again the loose ends of this section will be secured at the rear of the hive with Velcro, and the attached plastic parachute buckles clipped. Finally any slack in the corresponding straps is removed.

### How the Invention Works

Once fully assembled, the Hive Jacket will shield managed beehives from wind-chill and provide insulation through periods of extreme cold allowing the bees inside the hive to more easily regulate their own temperature.

### How to Make the Invention

This invention would most likely be manufactured in a factory where the individual components that make up the sections are readily available. All fabric components will be cut to size using patterns in much the same way garments are mass-produced. Next all the components will be sewn together and straps and Velcro attached.

### How to Use the Invention

The Hive Jacket should be used when outdoor temperatures drop and remain at a freezing or subfreezing level. This invention is only intended for use through the winter months and removed when there is no longer a sustained period of sub-freezing outdoor temperatures.

1. This invention insulates a hive by using separate sections, which shall wrap around a managed bee hive and attach at the rear using Velcro and Straps with Clasps.

2. This invention is designed to be modular so that numerous sections can be used to fit any height bee hive body.

3. The sections of this invention attach to one another using Velcro strips at the top and bottom edge of each section.

4. This invention is designed to fit the following sized managed bee hive bodies (lansgtroth bee hive); 8 frame, 10 frame, colony nucs, and hive bodies with external box type handles.
